(19) United States
(12) Patent Application Publication
(10) Pub. No.: US 2019/0255564 A1
(43) Pub. Date: Aug. 22, 2019

(54) OMNIPHOBIC POROUS MEMBRANE AND METHODS FOR PREPARING THE SAME

(71) Applicant: THE UNIVERSITY OF HONG KONG, Hong Kong (CN)

(72) Inventors: Liqiu WANG, Hong Kong (CN); Ping An ZHU, Hong Kong (CN)

(21) Appl. No.: 16/347,497

(22) PCT Filed: Nov. 4, 2016
(86) PCT No.: PCT/CN2016/104658

§ 371 Date: May 3, 2019

(51) Int. Cl. B05D 5/08; B01D 69/02; B01D 67/00

(52) U.S. Cl. CPC B05D 5/08; B01D 69/02; B01D 67/0009; B01D 2325/021; B05D 2518/10; B01D 2325/44; B01D 2323/22; B05D 2401/00; B01D 2325/028

(57) ABSTRACT

A liquid-repellent surface is provided where the repellency arises solely from the re-entrant surface structure. The liquid repellent surface is a porous membrane that contains hexagonally packed microcavities, each of which has a narrow opening located on its top. The surface is mechanically robust because the microstructures are interconnected in a continuous manner. A method of preparing the liquid repellent surface is also provided, which involves producing a uniform emulsion containing monodisperse micro-droplets, depositing the emulsion onto a substrate, and solidifying the emulsion-deposit by evaporating the solvent in the continuous phase fluid.

### CROSS-REFERENCE TO RELATED PATENT APPLICATIONS

This application is a U.S. National Phase Application under 35 U.S.C. § 371 of International Patent Application No. PCT/CN2016/104658, filed Nov. 4, 2016, which is incorporated herein by reference in its entirety. The International Application was published on May 11, 2018 as No. WO/2018/082024 A1.

### FIELD OF THE INVENTION

This invention generally relates to liquid-repellent solid surfaces and fabrication methods.

### BACKGROUND OF THE INVENTION

Omniphobic surfaces, with apparent contact angles larger than 90° for both water and low-surface-tension liquids, have tremendous potential applications, such as self-cleaning, chemical shielding, non-fouling, water-oil separation, etc. To obtain omniphobicity, i.e., the ability to repel water (hydrophobic) and oil (oleophobic), an overhang or re-entrant structure is essential. The re-entrant structure prevents the complete wetting of liquids (the Wenzel state), but maintains a composite solid-liquid-vapor interface (the Cassie state). The re-entrant topographic features can be either well-controlled or random. The former type includes micro-hoodoo, inverse-trapezoidal, microdisk, micro-pillar, and serif-T structures, while the latter includes colloidal particle assemblies and deposition of electrospun fiber. Compared to a random structure, a well-controlled topology can be systematically designed and optimized to achieve better omniphobicity. Surface topology also significantly influences the mechanical durability of the surface. The discrete surface structures, such as the pillar-like overhang structures, have very poor mechanical stability because a predetermined breaking point inevitably arises with the overhang part of the grooved side wall. In contrast, the self-supporting or continuous structures, for example, colloidal particle assemblies and fabrics, exhibit improved mechanical durability. To increase the longevity of surface repellency for pragmatic usage, a well-controlled omniphobic surface with robust mechanical stability is preferred.

Previous fabrication techniques have achieved considerable advances, but are still in great need of improvement to produce well-defined surfaces for long-term usage. Basically, the fabrication techniques are categorized into top-down and bottom-up methods. Top-down processes, such as lithography, enable the fabrication of well-defined surface morphology, but the surface mechanical stability is poor. In contrast, bottom-up approaches (including electrodeposition, electrospinning, spin-coating, spray coating, sol-gel synthesis and template-assisted synthesis) can produce self-supporting surfaces with better mechanical durability, but the surface structures are usually random. Very few methods are able to produce a mechanically-stable surface with well-defined structures.

### SUMMARY OF THE INVENTION

The present invention relates to a novel design of a porous surface or membrane which is both water and oil repellant with a re-entrant structure that is responsible for the surface omniphobicity, and a microfluidic emulsion templating method to fabricate the surface with well-controlled surface morphology. This morphology exhibits improved mechanical stability. Besides, the fabrication technique is facile, low-cost, generic and scalable.

In some exemplary embodiments of the present invention a liquid repellent surface comprises a porous membrane that has hexagonal densely-packed microcavities of a pancake-like shape. Each microcavity has a circular narrow opening at the center of its top. The size of the narrow opening and that of the microcavity can be independently varied. The narrow opening is smaller than the microcavity in size, whereby the re-entrant structure is generated on top of the surface. The minimum geometric angle of the microcavity lies at the rim of the narrow opening, with a value close to 0°. The re-entrant structure and the very low geometric angle (≈0°) contribute to the repellency of various liquids, denoted as omniphobicity. Because the microcavities are separated from each other by their vertical side-walls, the omniphobic surface enables reversible Cassie-to-Wenzel transition. In addition, the mechanical stability of the surface is improved because the microstructures of the surface are interconnected in a continuous manner. Moreover, since the surface is free-standing and flexible, the surface can be transferred onto objects with various shapes, while preserving the omniphobicity. Furthermore, the surface can be made optically transparent and chemically stable by choosing appropriate materials.

The present invention relates to a liquid repellent surface comprising: a porous membrane containing hexagonally packed microcavities, said microcavities having a narrow opening at the center of their top, wherein the narrow openings form a re-entrant structure responsible for the liquid repellency.

In one embodiment of the present invention, the microcavity is in a pancake-like shape.

In one embodiment of the present invention, the microcavities of the surface are identical or 50-99% identical or 60-99% identical or 70-99% identical or 80-99% identical or 90-99% identical.

In one embodiment of the present invention, the microcavity is packed.

In one embodiment of the present invention, the microcavities are separated from each other by vertical side-walls.

In one embodiment of the present invention, the thickness of the side-wall is smaller than the radius of the microcavity.

In one embodiment of the present invention, the radius of the microcavity is in the range of 3 microns to 600 microns, or 6 microns to 300 microns, or 9 microns to 200 microns.

In one embodiment of the present invention, the narrow opening is of a circular shape.

In one embodiment of the present invention, the narrow openings are identical or 50-99% identical or 60-99% identical or 70-99% identical or 80-99% identical or 90-99% identical.

In one embodiment of the present invention, the radius r of the narrow opening is in the range of 3 microns to 600 microns, or 6 microns to 300 microns, or 9 microns to 200 microns.

In one embodiment of the present invention, the ratio r/R of the radius r of the narrow opening to the radius R of the microcavity is in the range of 0 to 1.

In one embodiment of the present invention, the radius r of the narrow opening and the radius R of the microcavity are independently varied.

In one embodiment of the present invention, the height h of the surface is larger than the radius R of the microcavity.

In one embodiment of the present invention, the height h of the surface is larger than the radius r of the narrow opening.

In one embodiment of the present invention, the height h of the surface is in the range of 3 microns to 600 microns, or 6 microns to 300 microns, or 9 microns to 200 microns.

In one embodiment of the present invention, the minimum geometric angle of the microcavity is situated at the rim of the narrow opening.

In one embodiment of the present invention, the minimum geometric angle is close to 0°.

In one embodiment of the present invention, the surface enables reversible Cassie-to-Wenzel wetting transition.

In one embodiment of the present invention, the surface is mechanically robust in that it can withstand a sandpaper abrasion test applied for 10 cm in one direction and 10 cm in an orthogonal 90° direction at a constant speed of 0.5 cm/s for 40 cycles at a load below 8.6 kPa without significant damage.

In one embodiment of the present invention, the surface is optically transparent when made of optically transparent material such that for the light wavelength in the visible spectra ranging from 380 to 780 nm, the transparency is reduced by no more than 20% compared to bare glass.

In one embodiment of the present invention, the surface is flexible.

In one embodiment of the present invention, the surface is free-standing.

In one embodiment of the present invention, the surface is chemically stable if chemically stable material is used to form the microcavities.

The present invention further relates to a method of making a liquid repellent surface comprising:

producing a uniform emulsion containing monodisperse micro-droplets and continuous phase fluid by using microfluidic technique, wherein the continuous phase fluid comprises a solvent and solute or dispersible matter that can be solidified;

depositing the emulsion onto a substrate to form an emulsion-deposit; and

solidifying the emulsion-deposit by evaporating the solvent in the continuous phase fluid to form droplet templates.

The solvent is not necessary specifically limited and can comprise volatile solvent. For example, the volatile solvent may be one or more volatile solvents (at least as volatile as water, including water). In one embodiment of the present invention, the volatile solvent can include a member of ethanol, isopropyl alcohol, propanol, dimethylsulfoxide, dimethyl ether, diethyl ether, butane, propane, isobutene, ethyl acetate, acetone, water, or combinations thereof. In another embodiment of the present invention, the volatile solvent can include iso-amyl acetate, denatured alcohol, methanol, propanol, isopropylalcohol, isobutene, pentane, hexane, chlorobutanol, turpentine, cytopentasiloxane, cyclomethicone, methyl ethyl ketone, or combinations thereof. The volatile solvent can include a mixture or combination of any of the volatile solvents set forth in the embodiments above. A preferred volatile solvent is ethanol, water or a combination thereof.

In one embodiment of the present invention, the omniphobic surface or membrane of the present invention comprises or is made of an amphiphilic material or a solute or dispersible matter that can be solidified.

In one embodiment of the present invention, the amphiphilic material or the solute or dispersible matter that can be solidified can be selected from the group consisting of sulfonated hydrocarbons and their salts, poloxamers, polyoxyethylene alkyl ethers, polyoxyethylene sorbitan fatty acid esters, short-chain glyceryl mono-alkylates, polyglycolized glycerides, mono- and di-alkylate esters of polyols, polyoxyethylene 20 sorbitan monooleate, polyoxyethylene 20 sorbitan monolaurate, polyethylene (40 or 60) hydrogenated castor oil, polyoxyethylene (35) castor oil, polyethylene (60) hydrogenated castor oil, alpha tocopheryl polyethylene glycol 1000 succinate, glyceryl PEG 8 caprylate/caprate, PEG 32 glyceryl laurate, polyoxyethylene fatty acid esters, and solidifiable polymer such as polycarbonate, polyethylene (PE), polyethylene terephthalate (PET), polyethylene naphthalate (PEN), ethyl vinyl acetate (EVA) copolymer and polyvinyl alcohol (PVA), and mixtures thereof.

In one embodiment of the present invention, the solidifiable polymer may have a Mw of 1000 or greater, preferably a Mw of 6,000-60,000, more preferably a Mw of 10,000-40,000.

In one embodiment of the present invention, the continuous phase fluid comprises said solute or dispersible matter that can be solidified is in an amount of from 0.2 to 30%, from 0.5 to 20%, or from 1 to 15%, by weight, based on the weight of the continuous phase fluid. Said solute or dispersible matter may comprise a material selected from the group consisting of polymers of dextrose, sugars, starches, acrylates, polyvinyl alcohol, gum arabic, polyacrylamide, hydroxypropyl cellulose, hydroxypropyl methylcellulose, polyvinyl pyrrolidone, poly(2-acrylamido-2-methyl-1-propanesulfonic acid), poly(acrylamido-N-propyltrimethylammonium chloride), polylactic acid, polycaprolactone, polyglycolic acid, polylactic-co-glycolic acid, 1,3-propanediol polymer, collagen, gelatin, fibrin, silk-fibroin, elastin mimetic peptide polymer, chitosan, modified chitosan, polyvinylidene fluoride, polytetrafluoroethylene, polyurethane, polycarbonate polyurethane, polyether-based polyurethane, silane-modified polyurethane, polyethylene terephthalate, polymethyl methacrylate, poly(3-hydroxybutyrate-co-3-hydroxyvalerate), poly(3-hydroxybutyrate-co-3-hydroxyhexanoate), polyphosphate, polyamino formic anhydride, polyesteramide, poly(para-dioxanone), polycarbonate, cellulose, chondroitin sulfate, heparin, glucosan, alginic acid, alginate (preferably metal alginate, such as sodium alginate) polyethylene gycol, silicone rubbers, water and combinations thereof. For example the silicone rubbers may be selected from the group consisting of polysiloxanes, such as polyalkylsiloxanes, preferably polydimethylsiloxane (PDMS).

In one embodiment of the present invention, the droplets, the monodisperse micro-droplets, the dispersed droplet, or dispersed phase may selected from volatile and non-volatile silicone oils or fluids, vegetable oils and fats, animal fats, fish oils, hydrocarbons, halogenated hydrocarbons and mixtures thereof. For example, the vegetable oils and fats, animal fats or fish oils can comprise soybean oil, rapeseed oil, colza oil, canola oil, tall oil, sunflower oil, hempseed oil, olive oil, linseed oil, mustard oil, palm oil, peanut oil, castor oil, coconut oil, lard, tallow, train oil or fats contained in milk. For example, the hydrocarbons, halogenated hydrocarbons may be selected from higher alkanes or higher halogenated alkanes. The alkanes may be alkanes having 9 to 35 carbon atoms, or 9 to 25 carbon atoms. The example of the hydrocarbons and halogenated hydrocarbons include hexadecane, paraffin oil, perfluorobutylamine, perfluorodecahydronaphthalene, fluorocarbons, fluoroesters, fluoroethers, or combination thereof. The silicone compounds can be either linear or cyclic polydimethylsiloxanes with a viscosity from 0.5 to 100 cST, 10 to 50 cST or 15 to 30 cST. One example of a linear, low molecular weight, volatile polydimethylsiloxane is octamethyltrisiloxane.

In one embodiment of the present invention, the droplets, the monodisperse micro-droplets, the dispersed droplet, or dispersed phase may further include resins such as: “ABIL® S 201” (dimethicone/sodium PG-propyldimethicone thiosulfate copolymer), available from Goldschmidt; “DC Q2-8220” (trimethylsilyl amodimethicone) available from Dow Corning; “DC 949” (amodimethicone, cetrimonium chloride, and Trideceth-12), available from Dow Corning; “DC 749” (cyclomethicone and trimethylsiloxysilicate), available from Dow Corning; “DC2502” (cetyl dimethicone), available from Dow Corning; “BC97/004” and “BC 99/088” (amino functionalized silicone microemulsions), available from Basildon Chemicals; “GE SME253” and “SM2115-D2” and “SM2658” and “SF1708” (amino functionalized silicone microemulsions), available from General Electric; siliconized meadowfoam seed oil, available from Croda; and those silicone conditioning agents described by GAF Corp. in U.S. Pat. No. 4,834,767 [symbol] (quaternized amino lactam), by Biosil Technologies in U.S. Pat. No. 5,854,319 [symbol] (reactive silicone emulsions containing amino acids), and by Dow Corning in U.S. Pat. No. 4,898,595 [symbol] (polysiloxanes).

In one embodiment of the present invention, the method further includes the step of removing the droplet templates.

In one embodiment of the present invention, the fabrication is conducted in an ambient environment.

In one embodiment of the present invention, the method is applicable to a variety of materials, including polymers, composites, inorganic oxides, metals, and carbon.

In some embodiments of the invention a bottom-up method is used for making a liquid repellent surface. Such a method comprises the steps of: producing a uniform emulsion containing monodisperse micro-droplets by using a microfluidic technique; depositing the emulsion onto a substrate; solidifying the emulsion deposit by evaporating the solvent in the continuous-phase fluid; and removing the droplet templates. The fabrication process of the surface is facile, and can be conducted in a mild environment. In addition, the method is generic, applicable to various materials including polymers, composites, inorganic oxides, metals, and carbon. Because the fabrication method does not need expensive equipment, the cost of the method mainly arises from the cost of materials, which can be minimized by choosing cheap materials. Furthermore, the method can be scaled up to meet the demand of industrial-scale fabrication.

The omniphobic surface or membrane of the present invention is useful in applications such as self-cleaning, chemical shielding, non-fouling, anti-corrosion, anti-icing, drop manipulation and water-oil separation.

### BRIEF DESCRIPTION OF THE DRAWINGS

The foregoing and other objects and advantages of the present invention will become more apparent when considered in connection with the following detailed description and appended drawings in which like designations denote like elements in the various views, and wherein:

FIG. 1A shows a liquid drop on a smooth surface;

FIGS. 1B and 1C show two scenarios of a liquid droplet on textured surfaces, either in the Wenzel state (FIG. 1B), or in the Cassie state (FIG. 1C);

FIGS. 1D and 1E compare the detailed contact between a liquid and a solid structure of different minimum geometric angles;

FIG. 1F shows an overhang or re-entrant structure;

FIG. 2A shows a schematic top view of an omniphobic porous membrane with hexagonally packed microcavities according to the present invention;

FIG. 2B shows a schematic cross-section of the microcavity of FIG. 2A with re-entrant structure;

FIG. 2C illustrates a SEM image of the cross-section of one microcavity with a narrow opening on top;

FIG. 3A illustrates the fabrication process of the porous membrane with re-entrant microcavities of the present invention using a microfluidic emulsion templating method;

FIGS. 3B-3D show products of the three steps during the fabrication of the porous membrane according to the present invention;

FIG. 3E shows a wafer-scale fabrication of the porous membrane according to the present invention on an 8×8 cm substrate;

FIG. 4A shows four different sizes of droplets generated by a microfluidic device;

FIGS. 4B and 4C show the omniphobic porous membranes of two different sizes of the microcavity;

FIGS. 4D and 4E compare the omniphobic porous membranes with two different solid fractions;

FIGS. 5A and 5B illustrate the downward bend of the narrow opening rim when the surface is subjected to a large enough hydrostatic pressure;

FIG. 5C shows a highly reflective water-vapor interface between the beaded-up water droplet and the omniphobic porous surface;

FIG. 5D compares contact angles for ten liquids of various surface tensions on the omniphobic porous surface;

FIG. 5E is a graph comparing the measured contact angles and predictions from the Cassie-Baxter model for water and soybean oil on the omniphobic surface of the present invention;

FIG. 5F is a plot showing the contact angle hysteresis of various liquids on the omniphobic surface;

FIG. 6A illustrates two scenarios for the Cassie-to-Wenzel wetting transition, either by contact line depinning or by making contact with the substrate;

FIG. 6B is a graph showing the breakthrough pressure versus narrow opening diameter, and the theoretical prediction of breakthrough pressure in the depinning case (P_{θ});

FIGS. 6C and 6D show the reversible Cassie-to-Wenzel transition on the omniphobic porous surface by successively pressurizing and depressurizing the liquid;

FIG. 7A shows the evaporation processes of water and DMC droplets on the omniphobic surface;

FIG. 7B is a graph that compares the hydrostatic pressure inside the liquid droplet (P_{drop}) and breakthrough pressure (P_{break}) for the Cassie-to-Wenzel transition during water and DMC droplet evaporation;

FIGS. 7C and 7D show the water-vapor interface during the water droplet evaporation, demonstrating the water in the Cassie state;

FIGS. 7E and 7F show the liquid-vapor interface during DMC droplet evaporation, except for several sparsely wetted microcavities;

FIG. 7G shows the residual of water ink on top of the omniphobic porous surface after evaporation;

FIGS. 8A and 8B show SEM images of the microcavity and microbead surfaces on the same length scale;

FIGS. 8C and 8D show the structure failure of the microcavity surface at increasing applied pressure;

FIGS. 8E and 8F show the structural failure of the microbead surface at increasing applied pressure;

FIG. 8G is a graph that compares the water contact angle versus applied pressure for microcavity and microbead surfaces;

FIG. 8H is a graph that shows the water contact angle versus abrasion cycle for a microcavity surface abraded at a pressure of 11.5 kPa with sandpaper;

FIG. 9A shows a water droplet beaded-up on a flexible porous membrane coated on a cylindrical steel rod;

FIGS. 9B and 9C show the flexibility of the omniphobic porous membrane subjected to twisting (FIG. 9B) and stretching (FIG. 9C);

FIG. 9D illustrates the deformation of the microcavity structure under increasing stretching strain;

FIG. 9E is a graph that compares the contact angle of soybean oil versus stretching strain in the direction of stretching and compression;

FIG. 10 is a plot that shows the contact angle of water droplets versus pH value in a range of 1 to 14;

FIGS. 11A and 11B illustrate, respectively, water and olive oil droplets beaded-up on the transparent omniphobic porous surface; and

FIG. 11C is a graph that shows UV-vis spectra of a bare glass substrate and the omniphobic surface coated glass.

FIG. 12A displays a porous membrane made from calcium alginate.

FIG. 12B shows a porous membrane made from Polydimethylsiloxane (PDMS).

### DETAILED DESCRIPTION OF THE INVENTION

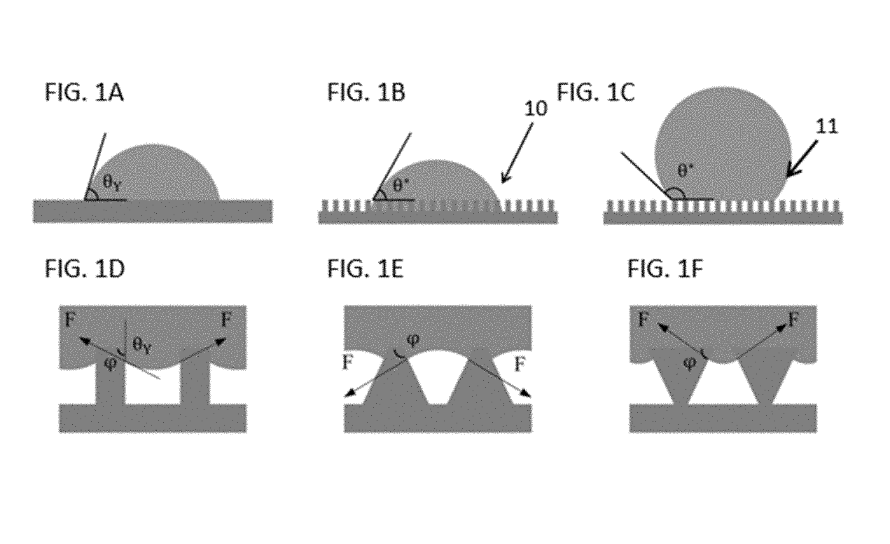

Wetting at liquid and solid interfaces is governed by surface chemistry and surface roughness. Consider a liquid drop deposited on a smooth surface at equilibrium, it adopts a static contact angle (CA) of θ_{γ} (determined by liquid and solid surface chemistry), as shown in FIG. 1A. When at equilibrium on a textured surface, the droplet has the apparent CA of θ*, in either the Wenzel state (where the liquid is in full contact with the solid surface at interface 10, FIG. 1B) or the Cassie state (where the liquid is in contact with the top of the textured surface with an air cushion 11 trapped underneath, FIG. 1C). A given liquid would have a larger apparent CA and smaller contact angle hysteresis in the Cassie state than in the Wenzel state. It is, therefore, preferable to maintain the liquid droplet in the Cassie state in achieving better liquid-repellency. However, a liquid with θ_{γ}<90° would energetically favor the Wenzel state on a textured surface. Meanwhile, in most situations θ_{γ} is smaller than 90° for liquids of low surface tension, such as oils and alkanes. This introduces great challenges in designing solid surfaces that repel both water and low-surface-tension liquids, a property usually denoted as omniphobicity.

To maintain a low-surface-tension liquid in the Cassie state, overhang or re-entrant structure is necessary. FIG. 1D depicts the localized contact between a liquid and the textured structure. Angle φ is the minimum geometric angle of the structure (the angle between the tangential line of the structure profile and the horizontal line). For a liquid of θ_{γ}>φ (FIG. 1D), the net force (arising from capillarity) on the liquid-vapor interface directs upward, maintaining the Cassie state. However, the case of θ_{γ}<φ (FIG. 1E) induces a downward pulling of the liquid-vapor interface until the liquid fully wets the surface. Consequently, to have the liquid in the Cassie state, φ must be smaller than θ_{γ}. For θ_{γ}<90°, φ should also be smaller than 90°, which can be forced to occur by adopting an overhang or re-entrant structure, as shown in FIG. 1F. Because θ_{γ}≥0° for any liquid, a structure with the geometric angle φ≤0° would have the possibility to repel all liquids, thereby possessing the omniphobicity.

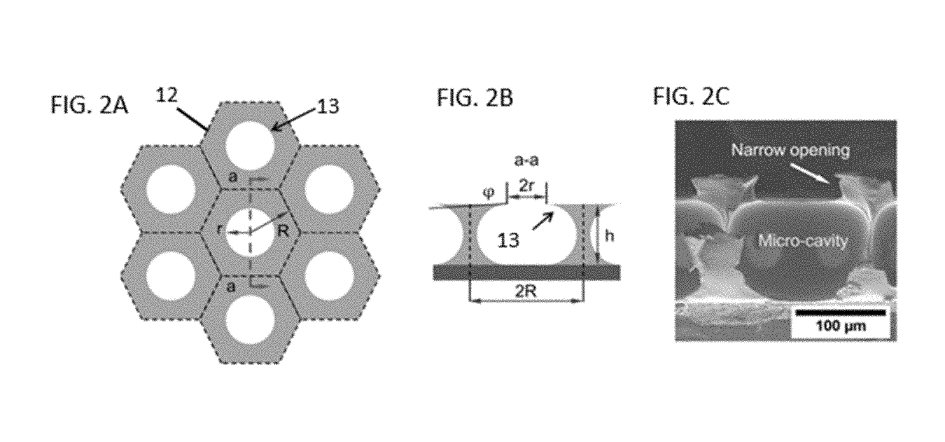

FIG. 2 illustrates the design of an omniphobic surface. The surface comprises hexagonally packed microcavities 12 with narrow openings 13 of radius r at the top of the surface and characteristic length R of the hexagonal cells, as shown in the schematic top view of FIG. 2A. The periodicity of the hexagonally-arrayed microcavity is, therefore, 2 R. FIG. 2B displays the cross-section of one hexagonal cell. The surface height is h. The minimum geometric angle φ occurs at the edge of the narrow opening with φ≥0° but very close to 0° if φ>0°. The microcavity is of a pancake-like shape with height h and diameter very close to the cell periodicity 2 R, because the thickness of the cell wall is much smaller than 2 R. FIG. 2C illustrates the SEM image of a microcavity, demonstrating an apparent narrow opening and re-entrant structure with φ≈0°. In FIG. 2C, the vertical cell wall and the edge of the narrow opening are on the same order of thickness, both of which are much smaller than the cell periodicity 2 R. As can be seen in FIG. 2A, the hexagonal cells are interconnected, resulting in a continuous structure of the omniphobic surface.

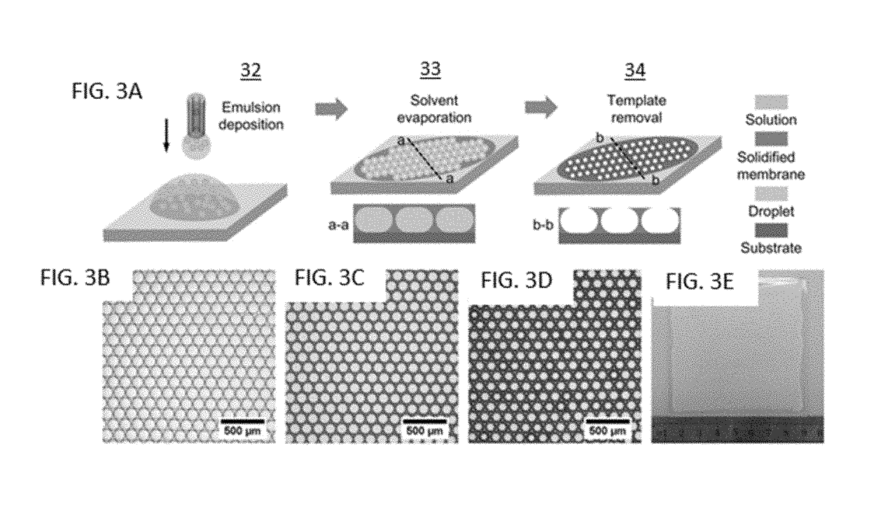

A schematic of the process for the fabrication of an omniphobic surface with a designed microcavity structure is shown in FIG. 3A. A modified emulsion templating method is adopted by generating the emulsion with microfluidic techniques. As such, the emulsion is highly uniform, containing monodispersed micro-droplets. The dispersed droplets serves as templates, and the continuous phase fluid is a solution of volatile solvent and solute or dispersible matter (polymers, nanoparticles, etc.) that can be solidified. This can be a Silicone-oil-in-PVA solution produced in capillary microfluidics. The dispersed phase can be Silicone oil (20 cST) with a Dow Corning 749 Fluid that can be used as a surfactant. The Continuous Phase can be PVA (M_{w} 13,000-23,000, 87-89% hydrolyzed) aqueous solution with a Solute Concentration: 2 wt %-10 wt %.

The emulsion is then deposited onto a substrate at Step 32 in FIG. 2A. Within several minutes, the dispersed droplets creamed to the air-water interface and self-assembled into hexagonally packed arrays, as shown in FIG. 3B. The next step is solvent evaporation (Step 33) in the continuous-phase fluid, during which the initial emulsion solidifies into a pancake-like membrane embedded with dispersed droplets. See FIG. 3C. The cross-sectional view a-a shows the wrapped oil droplets after water evaporation. Finally the droplet templates are removed (Step 34), e.g., by soaking in toluene (99.8%) for 2 hours to eliminate oil templates. The membrane is incorporated with hexagonally packed microcavities (as shown in FIG. 3D), in the same form of that in FIG. 2. The PVA porous membrane can be dried under a vent hood before use. The cross section b-b shows the formation of the narrow opening atop each microcavity. In some cases, the final step of template removal is not needed when the dispersed droplet is volatile.

The current fabrication method is denoted as a “microfluidic emulsion templating” (MET) method, owing to the use of microfluidic technique in producing emulsions. The MET method is facile, generic, scalable, and low-cost. First, MET involves a 3-step fabrication process: emulsion deposition, solvent evaporation, and template removal. The series of fabrication processes do not require a harsh environment (such as high temperature, ultra-high/low pressure) and are easy to carry out. They may be carried out at ambient temperature and pressure. Secondly, the MET method is applicable to a variety of materials, including polymers, composites, inorganic oxides, metals, and carbon. In principle, any material can be made to have a omniphobic surface with the current microcavity structure as long as the material is soluble (for instance polymers) or dispersible (for example nanoparticles) in a volatile solvent and can be solidified. Thirdly, the MET method is scalable. FIG. 3E displays a wafer-scale fabrication of an omniphobic surface on an 8×8 cm glass substrate. The surface can be fabricated on larger substrates. Finally, the cost of the MET fabrication is low. For example, fabrication of an 8×8 cm membrane as shown in FIG. 3E only consumes 0.1 grams of polymer (polyvinyl alcohol or PVA) and 0.05-0.1 grams of silicon oil (dispersed droplet). Consequently, the cost of material is roughly RMB 0.004-0.007 (assuming the cost of silicone oil is RMB 20/kg and PVA is RMB 30/kg.) Without expensive equipment, the method of the present invention is very cost effective.

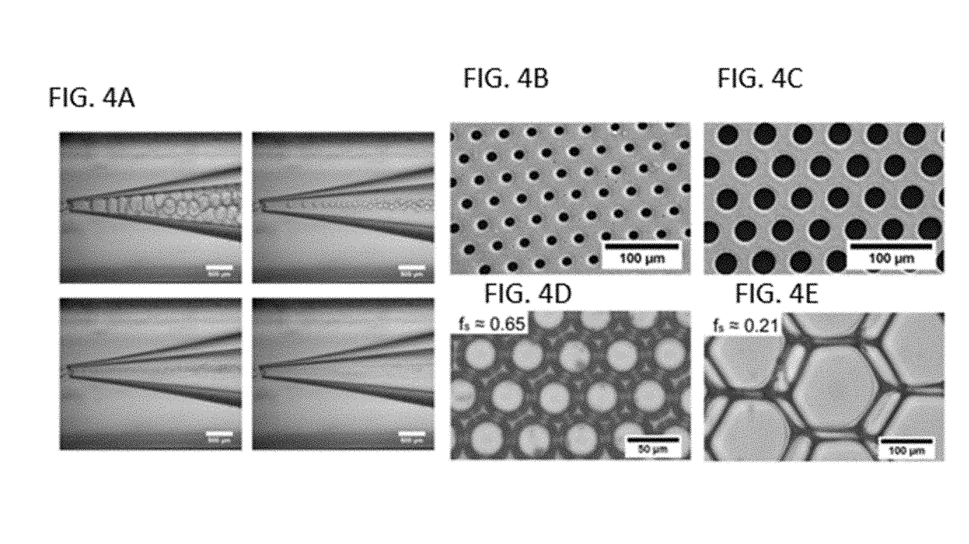

The MET method provides high controllability over the surface morphology. The three characteristic lengths of the omniphobic surface are the narrow opening radius r, hexagonal cell size R, and surface height h (FIG. 2). The size of the narrow openings r can be controlled by oil droplet size and PVA solution concentration. The values for R and h are of the same order of magnitude, determined by the dispersed droplet size. Using microfluidic techniques, monodispersed droplets can have their radius in a range from several microns to hundreds of microns, as shown in FIG. 4A. As such, both R and h are tunable in the range of several to hundreds of microns. FIGS. 4B and 4C illustrate surfaces with two cell sizes R. Narrow opening r is in the range of 0≤r≤R, and can be independently tuned by varying the concentration of the continuous solution. In FIGS. 4B and 4C the opening sizes are about 12 and 27 μm, respectively. The larger concentration renders r smaller. Consequently, the ratio of r to R can be continuously varied. Theoretically, the ratio r/R is related to the solid fraction of the surface fₛ (surface area of the solid part to the area of the whole surface) of the form

$${f}_{s} = 1 - \frac{π}{2 \sqrt{3}} {( \frac{r}{R} )}^{2} ,$$

which is in the range of 1−π/2√3 (≈0.09, when r=R) to 1 (when r=0). FIGS. 4D and 4E illustrate two surfaces with solid fractions fₛ of 0.65 and 0.21, respectively. In addition, in FIG. 4E, the re-entrant structure (r<R) of the narrow opening can be observed.

### EXPERIMENTAL RESULTS

### 1. Omniphobicity

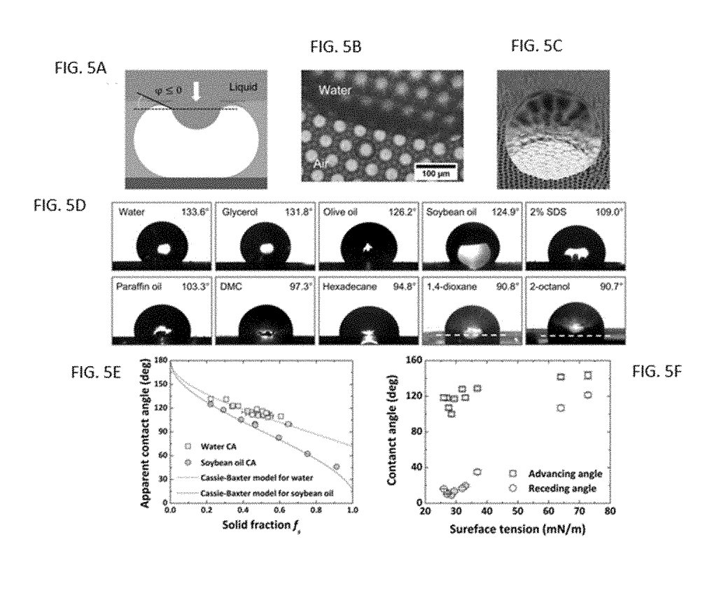

With a re-entrant structure, the surface is expected to possess omniphobicity: repelling both water and oils. As denoted before, the minimum geometric angle φ is close to 0° for the fabricated solid surface (FIG. 2C). If the surface is made of flexible materials (such as polymers), the protruding edge of the top narrow opening would bend downward easily when subjected to a pressure. The minimum geometric angle φ, therefore, can be smaller than 0° for the bent edge, as illustrated in FIG. 5A. In the case of φ≤0°, the surface has the possibility to repel any liquids (as φ≤0°≤θ_{γ} for all liquids). In practice, the hydrostatic pressure in a liquid droplet arising from Laplace pressure is large enough to bend the top edge. FIG. 5B is an optical image with a water droplet deposited on a PVA surface. The rims of the narrow opening are observed to wrinkle under the water-covering part (dashed circle in FIG. 5B), in high contrast to the intact rim in the water-free part (solid circle in FIG. 5B). With this effect, a liquid drop stays in the Cassie state when deposited on the surface. FIG. 5C displays a water droplet that beads up on the surface, where a liquid-vapor interface is manifested by the highly reflective area in the water-surface contact part.

TABLE 1
Material property of ten tested liquids

| | Surface tension | | |
|---|---|---|---|
| Liquid | (mN/m) | θ_{γ} (°) | θ* (°) |
| Water | 72.8 | 71.7 | 133.6 |
| Glycerol | 64 | 68.4 | 131.8 |
| 2% SDS | 36.5 | 15.1 | 109.0 |
| 1,4-dioxane | 33 | 8.6 | 90.8 |
| Olive oil | 32 | 25.9 | 126.2 |
| Soybean oil | 29.43 | 17.2 | 124.9 |
| DMC | 28.5 | 9.5 | 97.3 |
| 2-octanol | 27.6 | 10.0 | 90.7 |
| Hexadecane | 27.1 | 15.1 | 94.8 |
| Paraffin oil | 26 | 15.9 | 103.3 |

FIG. 5D illustrates the measurement of apparent CA θ* for ten different liquids: water, glycerol, olive oil, soybean oil, 2% sodium dodecyl sulfate (SDS), paraffin oil, dimethyl carbonate (DMC), hexadecane, 1,4-dioxane, and 2-octonal. These liquids contain polar (such as water), nonpolar (such as 1,4-dioxane), organic (such as oils), and inorganic (such as glycerol) types, and the CA values for all the tested liquids are higher than 90°. These results demonstrate that the surface repels all types of liquids, displaying omniphobicity. In addition, the omniphobic surface in FIG. 5D is made of an amphiphilic material (PVA): contact angles of the liquids on the smooth surface θ_{γ} are all smaller than 90° (Table 1). This result suggests that by micro-texturing the initial amphiphilic PVA material with a microcavity structure, the surface can be modified to be omniphobic without any surface chemistry modification. Consequently, the current MET method is able to make any material omniphobic.

Since the liquid droplet is in the Cassie state, the apparent CA θ* is described with the Cassie-Baxter model:

cos θ*=fₛ cos θ_{γ}−1+fₛ. (1)

where θ_{γ} is the equilibrium contact angle and fs is the solid fraction at the top of the PVA membrane.

According to Eq. (1), the apparent CA θ* decreases with the solid fraction fₛ for a given liquid of constant θ_{γ}. This result is validated in FIG. 5E. The experimental measurements of θ* agree well with the Cassie-Baxter model for both water and soybean oil, whose θ_{γ} value are 71.7° and 17.2°, respectively. In addition, for a given solid fraction fₛ, the larger θ_{γ} renders apparent CA θ* larger, as can be seen in FIG. 5E. The contact angle CA value of water is larger than that of soybean oil for every fₛ. FIG. 5F illustrates the contact angle hysteresis of various liquids on the solid surface by measuring the advancing and receding angles of the membrane, indicating a surface tension dependent contact angle hysteresis. The contact angle hysteresis is denoted as the difference between these two contact angles. An increase in contact angle hysteresis is observed with the decrease of liquid surface tension. By decreasing the solid fraction fₛ and lowering the solid surface energy, the contact angle hysteresis can be decreased for all liquids.

### 2. Breakthrough Pressure

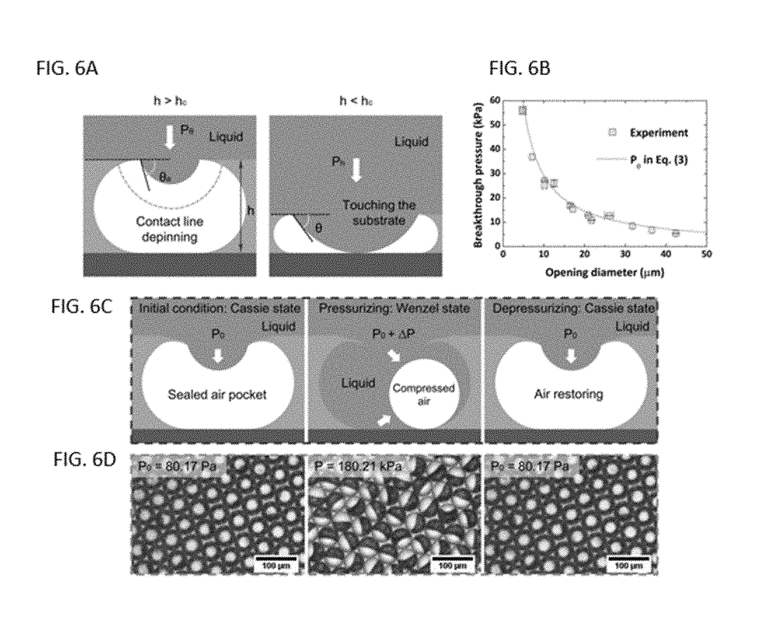

The Cassie state is a metastable state. Thermodynamically, the Wenzel state has a lower energy level than the Cassie state when θ_{γ}<90°. Therefore, the Wenzel state is more stable than the Cassie state, and the Cassie state will transition into the Wenzel state when the pressure is large enough. There can be many origins of the elevated pressure: hydrostatic pressure arising from Laplace pressure, hydrostatic pressure owing to the immersion of a solid surface under a liquid, a droplet impacting onto the solid surface, vibration from the environment, etc. The critical pressure that induces such a wetting state transition is denoted as the breakthrough pressure P_{break}. Consider the omniphobic surface with re-entrant microcavities, two transition scenarios would occur depending on the height h of the surface (FIG. 6A): depinning where the three phase contact line slides down along the side walls of the cavity when h>h_{c} (h_{c} is a critical height of the surface), and touching where the tip of the liquid meniscus contacts the bottom of the surface when h<h_{c}. The critical pressure for the Cassie-to-Wenzel transition is P_{break}=P_{θ} in the depinning case, and P_{break}=Pₕ in the touching case.

By calculating the critical capillary pressure when the transition occurs, P_{break} is determined theoretically:

$$\begin{matrix}for {θ}_{a} < 90 ° + ϕ \text{:} {P}_{break} = \{ \begin{matrix}{P}_{θ} = \frac{2 γ sin ( {θ}_{a} - ϕ )}{r} , h > \frac{r sin ( {θ}_{a} - ϕ )}{1 + cos ( {θ}_{a} - ϕ )} = {h}_{c} \\ {P}_{h} = \frac{4 h γ}{{h}^{2} + {r}^{2}} , h < {h}_{c}\end{matrix} , & ( 2 ) \\ for {θ}_{a} \geq 90 ° + ϕ \text{:} {P}_{break} = \{ \begin{matrix}{P}_{θ} = \frac{2 γ}{r} , h > r = {h}_{c} \\ {P}_{h} = \frac{4 h γ}{{h}^{2} + {r}^{2}} , h < {h}_{c}\end{matrix} , & ( 3 )\end{matrix}$$

here θₐ is the advancing angle of the liquid on a smooth surface, and γ is the liquid surface tension. Since θₐ and γ are determined by material chemistry, P_{break} largely depends on the height h of the surface when the materials of surface and liquid are given. Compared with the case of h<h_{c}, that of h>h_{c} makes the breakthrough pressure P_{break} larger, as can be seen from Eqs. (2)-(3). The larger P_{break} indicates a more stable Cassie state of liquids. For the surface fabricated by MET method of the hexagonally packed microcavities according to the present invention, the height h of the surface is determined by the size of the droplet templates. By considering that a spherical droplet of radius R deforms into a hexagonal cell of size R as shown in FIG. 2, one can easily find out that h≥2√3πR/9>R>r≥h_{c} by using droplet volume conservation. Consequently, wetting transition on the microcavity omniphobic surface always occurs in the depinning case. Consider water of θₐ=93.4±0.9° on the smooth PVA surface, and φ≤0°, the breakthrough pressure P_{break} is predicted by Eq. (3) to be P_{break}=P_{θ}=2γ/r. This result is experimentally validated by measuring P_{break} over various opening diameters (2 r), as illustrated in FIG. 6B.

To achieve robust omniphobicity, three parameters are quite important: minimum geometric angle φ, solid fraction fₛ, and breakthrough pressure P_{break}. The first criterion φ≤θ_{γ} enables the formation of the liquid droplet in the Cassie state. Secondly, the apparent CA θ*>90° requires that fₛ exceed a threshold for a given value of θ_{γ}. According to Eq. (1), fₛ≤0.5 is a sufficient condition for θ*>90° with respect to any θ_{γ}. Generally, the smaller the fₛ, the better the omniphobicity. Finally, P_{break} describes the stability of the Cassie state. Energetically, transition from the Cassie state to the Wenzel state has to overcome an energy barrier. From the force balance point of view, an applied force is needed to achieve such a transition. As such, the larger the energy barrier, the larger is the applied force P_{break} that is needed. To have a stable Cassie state, P_{break} must be large enough. The current omniphobic surface with re-entrant microcavity has an intrinsic φ≈0°; the MET method enables the formation of a surface with a solid fraction fₛ ranging from 1−π/2\sqrt{3} (≈0.09) to 1; P_{break} is determined by the depinning pressure, which is larger than touching pressure (FIG. 6A). Since r and R can be tuned independently, fₛ and P_{break} are unrelated. This suggests the possibility of making fₛ small and P_{break} high by setting r/R large, while r is small. These results show the advantages of the microcavity surface and the MET method for its fabrication in achieving robust omniphobicity.

Because of the closed hexagonal cell, the omniphobic surface enables a reversible Cassie-to-Wenzel transition. Generally, the transition from Cassie to Wenzel state is irreversible due to the minimization of energy. Exceptions include applying external stimuli such as heating, electrowetting, electrochemical gas generation, etc. In the microcavity surface, the air pocket is sealed inside the closed cavity when, for example, the surface is immersed into a liquid. Initially, the hydrostatic pressure is P₀, where the liquid is in the Cassie state, as illustrated in FIG. 6C. Upon increasing the pressure to P=P₀+ΔP (such as increasing the depth of the immersion), the air pocket is compressed but still stays inside the microcavity. In this case, the Cassie state transitions into the Wenzel state. However, the Wenzel state would transition back into the initial Cassie state when the elevated hydrostatic pressure is released, for example, by decreasing the immersion depth. In the latter transition, the compressed air pockets expand due to the decrease in the hydrostatic pressure, pushing the invaded liquid outside the microcavity. The schematics in FIG. 6C illustrate this reversible Cassie-to-Wenzel transition process. Meanwhile, the images of experimental results in FIG. 6D confirm the reversible transition. Initially, P₀=80.17 Pa, the liquid (water) is in the Cassie state. When the pressure is increased to 180.21 kPa, the Cassie state transitions to the Wenzel state. It is now observed that every microcavity is in a Janus state: the white part indicates water invasion, while the black part denotes the compressed air. Then, the Cassie state is restored when the pressure decreases back to 80.17 Pa.

### 3. Droplet Evaporation

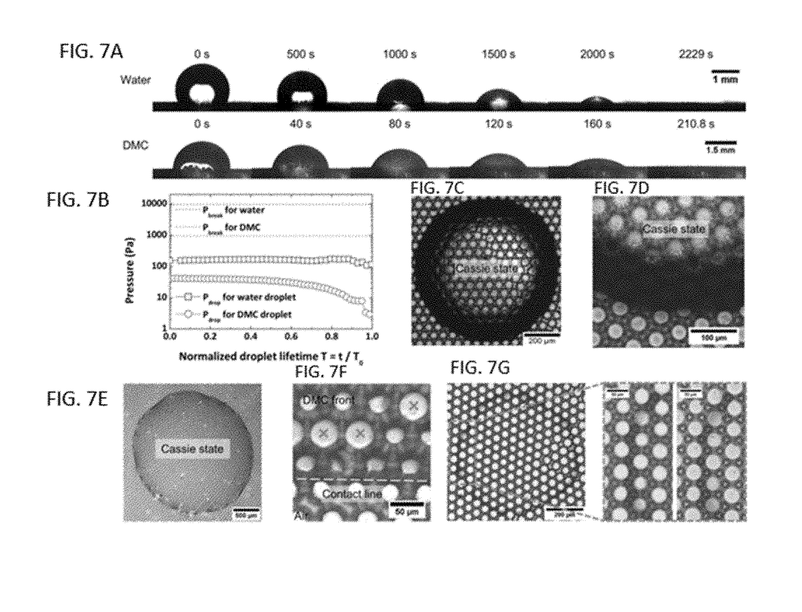

For many hydrophobic, oleophobic, and omniphobic surfaces, the Cassie state will transition to the Wenzel state during droplet evaporation. This is because the hydrostatic pressure inside the droplet (P_{drop}=2γ/R_{drop}) increases as the size of the droplet R_{drop} decreases during evaporation. However, such a transition is not observed in the microcavity surface of the present invention. FIG. 7A presents the process of a water and DMC droplet evaporating on the microcavity surface. It can be seen that both the apparent CA θ* and base radius R_{base} (radius of the circular contact area between liquid and solid surface) get smaller and smaller for water evaporation, while θ* decreases but R_{base} keeps nearly constant for DMC droplet evaporation. Extracting θ* and R_{base} for water and DMC during evaporation, the hydrostatic pressure P_{drop}=2γ/R_{drop} is displayed in FIG. 7B. As denoted before, the Cassie-to-Wenzel state transition occurs when the pressure P exceed the breakthrough pressure P_{break}, which is also plotted in FIG. 7B for water and DMC. Because P_{break}>P_{drop} for both water and DMC during the whole evaporation lifetime, no Cassie-to-Wenzel transition occurs.

The above statement is confirmed by FIGS. 7C-7F, which illustrate respectively the transmittance images of a water and DMC droplet during evaporation, observed under an optical microscope. In FIGS. 7C and 7D, a water-vapor interface is observed, indicating the Cassie state. In FIGS. 7E and 7F, the liquid-vapor interface is observed on most microcavities, except that several cavities are sparsely wetted by DMC (marked by cross symbols in FIG. 7F). The wetting of the cavities is probably due to defects on the rims of the narrow openings. To further verify the Cassie state during evaporation, a drop of water ink solution is deposited on the microcavity surface. After evaporation, an ink residual is left on the top of the surface, as illustrated in FIG. 7G. In the magnified images of FIG. 7G, the left image is focused on the bottom layer of the surface, while the right magnification is focused on the top layer. It can be seen that the residual is clearer in the right magnification than the left, suggesting that the residual remains on the top layer of the surface.

### 4. Sandpaper Abrasion Test

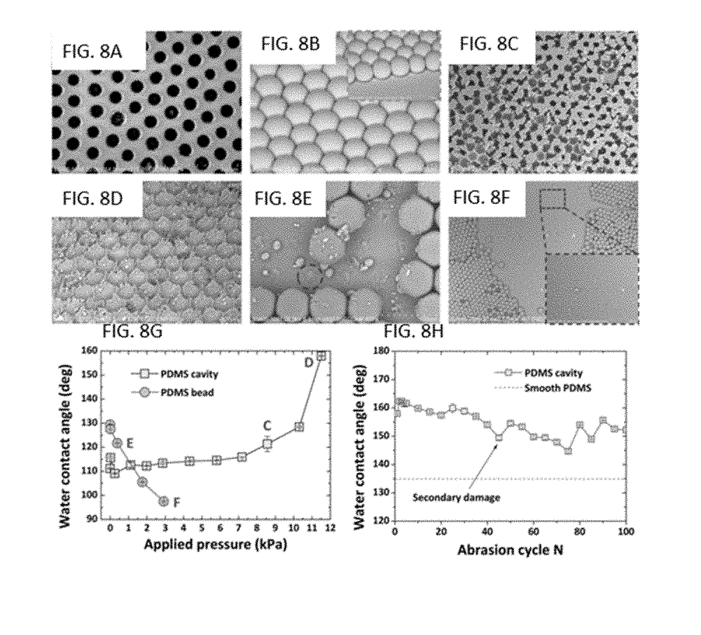

The microcavity surface exhibits improved mechanical stability compared to surfaces with discrete structures such as pillars, nails, beads, etc. The improved mechanical stability arises from the continuous structure of interconnected hexagonal cells. To demonstrate the improved mechanical stability, a microcavity surface and a microbead surface are fabricated, as illustrated in FIGS. 8A and 8B. The hexagonal cell size in FIG. 8A and the bead size in FIG. 8B are the same, and both surfaces are made of the same material, i.e., PDMS, in order to isolate the effect of the structure type on the mechanical stability.

In testing the mechanical stability, the surface is placed face down to the sandpaper, and is forced to move along the sandpaper for a distance of 10 cm at a constant speed of 0.5 cm/s. Then the surface is rotated 90° but is still kept facing down on the sandpaper and is moved for another 10 cm at the same speed. This is one cycle of the abrasion test. During movement, the abrasion between the surface and the sandpaper will destroy the structure if the friction is large enough. To increase the friction, a load is applied to the surface as it moves on the sandpaper. By increasing the load, the applied pressure on the surface increases. In the test, the applied pressure is increased gradually. For every value of the pressure, one cycle test is applied. With the increase in the applied pressure, the surface structure is destroyed gradually. FIGS. 8C-8F illustrate, respectively, the destruction of the microcavity and the microbead structures at increasing pressure. In FIG. 8C, part of the top layer of the microcavity surface is destroyed at 8.6 kPa, while in FIG. 8D, the top layer is totally destroyed at 11.5 kPa. However, the surface roughness in FIG. 8D is still very high, due to the existence of the bottom part of the microcavity. In comparison, some of the microbeads fail at a pressure of 0.4 kPa (FIG. 8E), and large areas of microbeads are removed at a pressure of 2.9 kPa (FIG. 8F). In contrast to the microcavity structure, the failure of the microbead structure occurs at the bottom layer (dashed circle in FIG. 8E), which means the elimination of the microbead structure decreases the surface roughness, as shown in FIG. 8F. In addition, the critical pressure for the failure of the microbead structure (around 0.4 kPa) is about 21.5 times smaller than for the microcavity structure (around 8.6 kPa). This result signifies an improved mechanical stability of the continuous microcavity structure over that of the discrete microbead structure.

The difference between the destruction of the two structures is also manifested in the variation of the water CA versus applied pressure, as illustrated in FIG. 8G. For the microcavity, the apparent CA is nearly constant between 110° and 115° when applied pressure is below 8.6 kPa. This suggests no failure of the structure. Starting from 8.6 kPa, the water CA increases significantly with applied pressure. In the range of 8.6 kPa to 11.5 kPa, the extent of structure destruction deepens, increasing the surface roughness (i.e., fₛ becoming smaller), which makes water CA larger. However, the opposite is observed for the microbead structure. The water CA is found to be around 130° for pressure below 0.4 kPa, indicating a non-failure of the structure. However, an apparent decrease of CA with applied pressure is observed when the pressure exceeds 0.4 kPa. The decrease of CA is attributed to the decrease in the surface roughness (i.e., fₛ becoming larger) with applied pressure.

To further test the lifetime of the microcavity structure, the surface is abraded with the sand paper under a loading pressure of 11.5 kPa. FIG. 8H illustrates the variation of water CA versus the abrasion cycle. In the first 40 cycles, the water CA is larger than 150°, and the adhesion of water droplet on the surface is observed to be very small. After 40 cycles of abrasion, the water CA has large amplitude fluctuations around 150°, and the adhesion is observed to increase significantly. These results suggest secondary damage of the surface structure after 40 cycles when the bottom structure shown in FIG. 8D is damaged by abrasion. After a 100-cycle test, the bottom structure is observed to be totally eliminated.

### 5. Flexibility

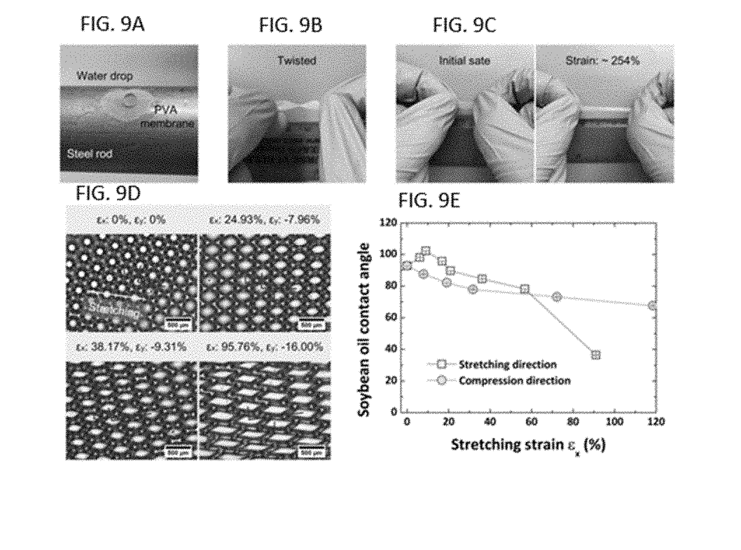

The microcavity omniphobic surface can be made flexible by choosing soft materials, for example, polymers. The surface is also free-standing, after being peeled from the substrate. Incorporating these two properties, the surface can be transferred onto various materials of various shapes as a coating. This causes the materials upon which it has been coated to have omniphobicity. FIG. 9A illustrates a flexible omniphobic surface coated on a cylindrical steel rod or pasted on using double faced adhesive tape. A water drop beads up on the coated rod surface. The flexible surface can even be twisted (FIG. 9B) and stretched to an extent, as illustrated in FIG. 9C, as large as 254% before failure. FIG. 9D presents the deformation of the microcavity when the surface is subjected to a unidirectional stretching along the x direction. Consequently, the surface is compressed in the orthogonal y direction. The positive strain εₓ, therefore, indicates the stretching and negative ε_{y} suggests compression. With the increase of the stretching strain, the shape of the microcavity (top view) deforms gradually from a circle to a parallelogram. FIG. 9E illustrates the soybean oil CA versus the stretching strain εₓ in both the stretching and compression directions. In the stretching direction, the CA firstly increases and then decreases with εₓ. The first increase stage is due to the decrease in solid fraction fₛ in the stretching direction. The later decrease stage of CA is attributed to the decrease in P_{break} as a result of the increase of the narrow opening radius r in the stretching direction. Therefore, the Cassie-to-Wenzel transition occurs. For strain smaller than 20%, it is observed in FIG. 9E that the value of CA in the stretching direction is larger than the initial value before the surface is stretched. In the compression direction, the soybean oil CA decreases monotonically with εₓ, in that fₛ in the compression direction increases (because r decreases in the compression direction).

### 6. Chemical Stability Test

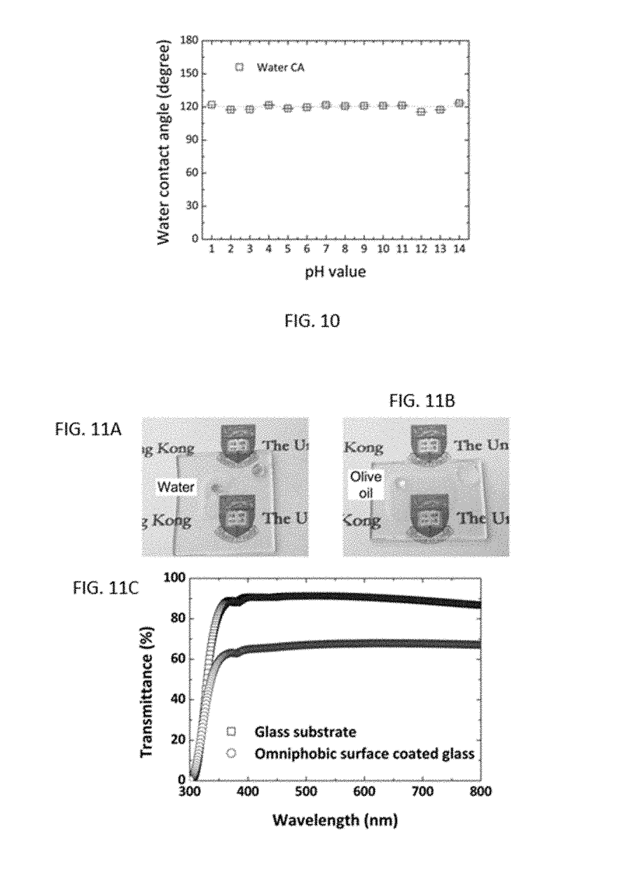

Since the omniphobicity arises from the re-entrant surface structure, the omniphobic surface is expected to be chemically stable as long as the microcavity structure is preserved. As such, a microcavity surface is workable in a wide range of pH values by using a chemically-stable material. To cite one example, PVA can be cross-linked with glutaraldehyde (GA) to avoid dissolution in an aqueous solution and to preserve its integrity in a wide range of pH values. To test the chemical stability of the PVA omniphobic surface, the CAs of water droplets with a pH value ranging from 1 to 14 are measured. HCl and NaOH are used to tune the water droplet from acid to alkali, respectively. FIG. 10 illustrates the CA versus pH value. For all the tested pH values, the CA basically kept constant with a value similar to the pure water CA (at pH=7). These results indicate that the cross-linked PVA is chemically stable, consistent with what would be expected.

### 7. Transparency

The omniphobic surface is transparent due to the absence of any sub-micrometer structures, thus avoiding the scattering of visible light. FIG. 11 shows water (FIG. 11A) and olive oil (FIG. 11B) droplets on the microcavity (left droplet) and a smooth part (right droplet) of the surface, respectively. The droplets bead up on the microcavity part, demonstrating the omniphobicity. Meanwhile, the logo underneath the porous part is highly visible. FIG. 11C contrasts the ultraviolet-visible (UV-vis) transmittance spectra for the omniphobic surface (solid fraction of 21%) coated glass and a bare glass substrate. For the light wavelength in the visible spectra ranging from 380 to 780 nm, the transparency of the omniphobic surface on a glass substrate is reduced by ˜20% compared to that of the bare glass substrate. It is believed that higher transmittance is possible by further decreasing the solid fraction of the omniphobic surfaces.

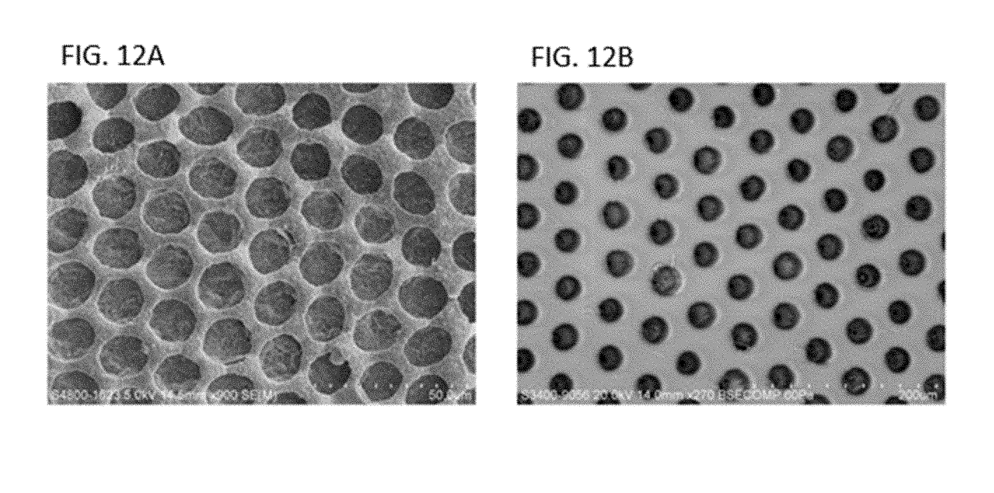

In addition to the above examples and embodiments of the present invention, FIG. 12A displays another example of the inventive porous membrane made from calcium alginate, wherein the dispersed phase is soybean oil (Sigma), and the continuous phase is sodium alginate (Sigma-Aldrich). The membrane is crosslinked with 6 wt % calcium chloride (Sigma-Aldrich) aqueous solution after the removal of soybean oil template.

In addition to the above examples and embodiments of the present invention, FIG. 12B shows another example of the inventive porous membrane made from Polydimethylsiloxane (PDMS), wherein the dispersed phase is n-hexadecane, and the continuous phase is PDMS oil with 10 wt % initiator (Sylgard® 184 Silicone elastomer kit, Dow Corning). The membrane is cured at 80° C. for 2 hours after the removal of n-hexadecane template.

While the present invention has been particularly shown and described with reference to preferred embodiments thereof; it will be understood by those skilled in the art that various changes in form and details may be made therein without departing from the spirit and scope of the invention.

1-8. (canceled)

9. A liquid repellent surface comprising:
a porous membrane containing hexagonally packed microcavities, said microcavities each having a narrow opening at the center of their top, wherein the narrow openings form a re-entrant structure responsible for the liquid repellency.

10. The liquid repellent surface of claim 9, wherein the microcavities are each in a pancake-like shape.

11. The liquid repellent surface of claim 9, wherein the microcavities of the surface are 90-90% identical.

12. The liquid repellent surface of claim 9, wherein the microcavities are separated from each other by vertical side-walls.

13. The liquid repellent surface of claim 9, wherein the thickness of each side-wall is smaller than the radius of the microcavity.

14. The liquid repellent surface of claim -9, wherein the microcavities each have a radius R that is in the range of 3 microns to 600 microns, and wherein the narrow openings each have a radius r that is in the range of 3 microns to 600 microns.

15. The liquid repellent surface of claim 14, wherein the ratio r/R of the radius r of the narrow opening to the radius R of the microcavity is in the range of 0 to 1.

16. The liquid repellent surface of claim 14, wherein the radius r of the narrow opening and the radius R of the microcavity can be independently varied.

17. The liquid repellent surface of claim 14, wherein the height h of the liquid repellent surface is larger than the radius R of the microcavity.

18. The liquid repellent surface of claim 14, wherein the height h of the liquid repellent surface is larger than the radius r of the narrow opening.

19. The liquid repellent surface of claim 9, wherein the height h of the liquid repellent surface is in the range of 3 microns to 600 microns.

20. The liquid repellent surface of claim 9, wherein the narrow openings are 90-99% identical.

21. The liquid repellent surface of claim 9, wherein a minimum geometric angle of the microcavity is situated at the rim of the narrow opening.

22. The liquid repellent surface of claim 21, wherein the minimum geometric angle is close to 0°.

23. The liquid repellent surface of claim 9, wherein the liquid repellent surface enables reversible Cassie-to-Wenzel wetting transition.

24. The liquid repellent surface of claim 9, wherein the liquid repellent surface is mechanically robust in that it can withstand a sandpaper abrasion test applied for 10 cm in one direction and 10 cm in an orthogonal (90°) direction at a constant speed of 0.5 cm/s for 40 cycles at a load below 8.6 kPa without significant damage.

25. The liquid repellent surface of claim 9, wherein the surface is optically transparent when made of optically transparent material such that in a range from 380 to 780 nm, the transparency is reduced by no more than ˜20% compared to bare glass.

26. A method of making a liquid repellent surface comprising:
producing a uniform emulsion containing monodisperse micro-droplets by using microfluidic technique;
depositing the emulsion onto a substrate; and
solidifying the emulsion-deposit by evaporating the solvent in the continuous phase fluid to form droplet templates.

27. The method of claim 26, further including the step of removing the droplet templates.

28. The method of claim 26, wherein the method is conducted in an ambient environment.
